(19) United States
(12) Patent Application Publication
(10) Pub. No.: US 2026/0246305 A1
(43) Pub. Date: Aug. 20, 2026

(54) RECTIFIER

(71) Applicant: Mitsubishi Electric Corporation, Tokyo (JP)

(72) Inventors: Toshiyuki TANAKA, Tokyo (JP); Hiroyuki MIZUTANI, Tokyo (JP); Yukihiro HOMMA, Tokyo (JP); Masaomi TSURU, Tokyo (JP)

(73) Assignee: Mitsubishi Electric Corporation, Tokyo (JP)

(21) Appl. No.: 19/469,395

(22) PCT Filed: Jan. 26, 2024
(86) PCT No.: PCT/JP2024/002507

§ 371 Date: Sep. 26, 2025

(30) Foreign Application Priority Data
Apr. 24, 2023 (JP) 2023-070750

(51) Int. Cl. H02J 50/27; H02M 1/14; H02M 7/06

(52) U.S. Cl. CPC H02J 50/27; H02M 1/14; H02M 7/066

(57) ABSTRACT

A rectifier includes a plurality of diodes, and also includes a rectifier circuit to generate a direct-current component upon input of a wave to be rectified, and a plurality of line members connected to the rectifier circuit. The plurality of diodes includes a first diode, a second diode, a third diode, and a fourth diode. The plurality of line members is even-order short-circuit members and smooths output of the rectifier circuit, and includes a first member having one end connected to the first diode and the other end being open, a second member having one end connected to the second diode and the other end being open, a third member having one end connected to the third diode and the other end being open, and a fourth member having one end connected to the fourth diode and the other end being open.

### TECHNICAL FIELD

The present disclosure relates to a rectifier for converting a high-frequency current to a direct current.

### BACKGROUND ART

As rectifiers for converting a high-frequency current in a microwave band to a direct current, bridge rectifiers are known each of which includes four diodes arranged in a bridge configuration. Such bridge rectifiers include those using shunt capacitors that are short-circuited to even-order harmonics (for example, see Patent Literature 1). The shunt capacitors are a plurality of capacitors disposed between an output side of bridge-connected diodes and a ground and each connected to a shunt.

### CITATION LIST

### Patent Literature

Patent Literature 1: Japanese Patent No. 5885149

### SUMMARY OF INVENTION

### Technical Problem

When a frequency band of a fundamental wave in a wave to be rectified exceeds 20 GHz, chip capacitors connected to the output side of the bridge-connected diodes have difficulty in becoming short-circuited to the even-order harmonics due to inductive components. In a higher frequency band, variations in performance of the capacitors have a greater influence. This increases performance differences between the rectifiers and degrades quality of the rectifiers.

The present disclosure is made in view of the above circumstances, and an objective of the present disclosure is to provide a rectifier capable of achieving high conversion efficiency with a simple circuit configuration and reducing variations in performance.

### Solution to Problem

In order to achieve the above objective, a rectifier according to the present disclosure includes a rectifier circuit and a plurality of line members. The rectifier circuit includes a plurality of diodes, and generates a direct-current component upon input of a wave to be rectified. The plurality of diodes includes a first diode and a third diode each having an anode connected to an input side of the rectifier circuit and a cathode connected to an output side of the rectifier circuit, and a second diode and a fourth diode each having a cathode connected to the input side of the rectifier circuit and an anode connected to the output side of the rectifier circuit. Each of the plurality of line members is an even-order short-circuit member that has an impedance of zero at at least one of even-order harmonics of the wave to be rectified and smooths output of the rectifier circuit, and has one end connected to one of the plurality of diodes and the other end being open.

### Advantageous Effects of Invention

In the present disclosure, each of the plurality of line members has an impedance of zero at at least one of the even-order harmonics of the wave to be rectified and smooths the output of the rectifier circuit. This achieves high conversion efficiency with a simple circuit configuration and reduces variations in performance.

### BRIEF DESCRIPTION OF DRAWINGS

FIG. 1 illustrates an exemplary configuration of a rectifier according to Embodiment 1;

FIG. 2 illustrates operating states of diodes and current paths in a rectifier circuit included in the rectifier according to Embodiment 1;

FIG. 3 illustrates other operating states of the diodes and other current paths in the rectifier circuit included in the rectifier according to Embodiment 1;

FIG. 4 illustrates time waveforms of currents flowing through the diodes in the rectifier according to Embodiment 1;

FIG. 5 illustrates time waveforms of the currents flowing through the diodes in the rectifier according to Embodiment 1;

FIG. 6 illustrates current paths of even-order harmonics in the rectifier according to Embodiment 1;

FIG. 7 illustrates current paths of the even-order harmonics in the rectifier according to Embodiment 1;

FIG. 8 illustrates an exemplary configuration of the rectifier according to Embodiment 1;

FIG. 9 illustrates another exemplary configuration of the rectifier according to Embodiment 1;

FIG. 10 illustrates another exemplary configuration of the rectifier according to Embodiment 1;

FIG. 11 illustrates an exemplary configuration of a rectifier according to Embodiment 2;

FIG. 12 is a diagram for explanation of a problem in the rectifier according to Embodiment 1;

FIG. 13 illustrates another exemplary configuration of the rectifier according to Embodiment 2;

FIG. 14 illustrates another exemplary configuration of the rectifier according to Embodiment 2;

FIG. 15 illustrates an exemplary configuration of a rectifier according to Embodiment 3; and

FIG. 16 illustrates another exemplary configuration of the rectifier according to Embodiment 3.

### DESCRIPTION OF EMBODIMENTS

Hereinafter, rectifiers according to embodiments of the present disclosure are described with reference to the drawings. In the drawings, the same reference signs are assigned to the same or equivalent parts.

### Embodiment 1

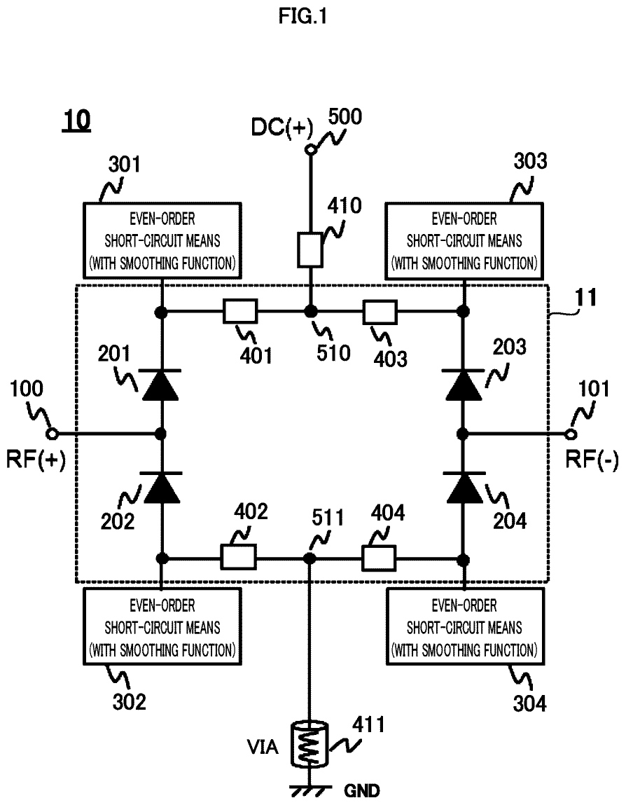

FIG. 1 illustrates an exemplary configuration of a rectifier 10 according to Embodiment 1 of the present disclosure. The rectifier 10 includes a rectifier circuit 11 that uses diodes, and a plurality of even-order short-circuit means 301 to 304 that are connected to the rectifier circuit 11. The rectifier 10 also includes input terminals 100 and 101 and an output terminal 500. The input terminals 100 and 101 are high-frequency input terminals to which a high-frequency signal is differentially input. The rectifier circuit 11 includes, as the plurality of diodes, four diodes 201 to 204 arranged in a bridge configuration. The diode 201 is a first diode in the rectifier circuit 11. The diode 202 is a second diode in the rectifier circuit 11. The diode 203 is a third diode in the rectifier circuit 11. The diode 204 is a fourth diode in the rectifier circuit 11. The rectifier circuit 11 converts a high-frequency wave to be rectified that is input to the input terminals 100 and 101 to generate a direct-current component. The output terminal 500 outputs a single-phase direct current. In the rectifier circuit 11, the single-phase direct current is output between the output terminal 500 and a ground GND. Therefore, a ground side connected to the ground GND also serves as an output side of the rectifier circuit 11.

When full-wave rectification is performed in the rectifier circuit 11 upon input of a high-frequency wave to be rectified to the input terminals 100 and 101, the even-order short-circuit means 301 to 304 are to be short-circuited, that is, have an impedance of zero at at least one of even-order harmonics of the wave to be rectified that are generated by the full-wave rectification. The even-order short-circuit means 301 to 304 also have a smoothing function that smooths output of the rectifier circuit 11. The harmonics of the wave to be rectified are signal waves included in the signals after rectification and having a frequency integral times the frequency of the wave to be rectified.

Connection of the diodes 201 to 204 in the rectifier circuit 11 is determined in view of a substrate wiring layout. For example, an anode of the diode 201 is connected to the input terminal 100 on an input side of the rectifier circuit 11. A cathode of the diode 201 is connected to a connection point 510 via a transmission line 401 on the output side of the rectifier circuit 11. An anode of the diode 203 is connected to the input terminal 101 on the input side of the rectifier circuit 11. A cathode of the diode 203 is connected to the connection point 510 via a transmission line 403 on the output side of the rectifier circuit 11. The connection point 510 is connected to the output terminal 500 via a transmission line 410. The rectifier 10 outputs a direct current from the output terminal 500. An anode of the diode 202 is connected to a connection point 511 via a transmission line 402 on the ground side of the rectifier circuit 11. A cathode of the diode 202 is connected to the input terminal 100 on the input side of the rectifier circuit 11. An anode of the diode 204 is connected to the connection point 511 via a transmission line 404 on the ground side of the rectifier circuit 11. A cathode of the diode 204 is connected to the input terminal 101 on the input side of the rectifier circuit 11. The connection point 511 is grounded by being connected to the ground GND on a backside surface of a substrate via a via 411.

The rectifier 10 is applicable to a rectenna. The rectenna is an antenna with a rectifier for converting a high-frequency current in a microwave band received by the antenna to a direct current. The conversion of a high-frequency current to a direct current is also referred to as RF-to-DC conversion. The rectenna is used as a power receiver in wireless power transmission (WPT). To achieve a highly-efficient transmission system, the rectifier included in the rectenna is required to have higher efficiency in the RF-DC conversion. To achieve the higher efficiency in the microwave rectifier, harmonics are required to be properly processed. The harmonics in the rectifier are generated by switching between on and off states of the diodes. The rectifier 10 aims to achieve the higher efficiency in the RF-to-DC conversion with a simple circuit configuration.

Next, operating states of the four diodes 201 to 204 and current paths in the rectifier circuit 11 are described when a high-frequency wave to be rectified is input to the input terminals 100 and 101. The rectifier circuit 11 is a bridge rectifier circuit including the plurality of diodes 201 to 204 as the bridge-connected diodes. Such a bridge rectifier circuit is included in a full-wave rectifier circuit. The rectifier circuit 11 generates a direct-current component upon input of a high-frequency wave to be rectified.

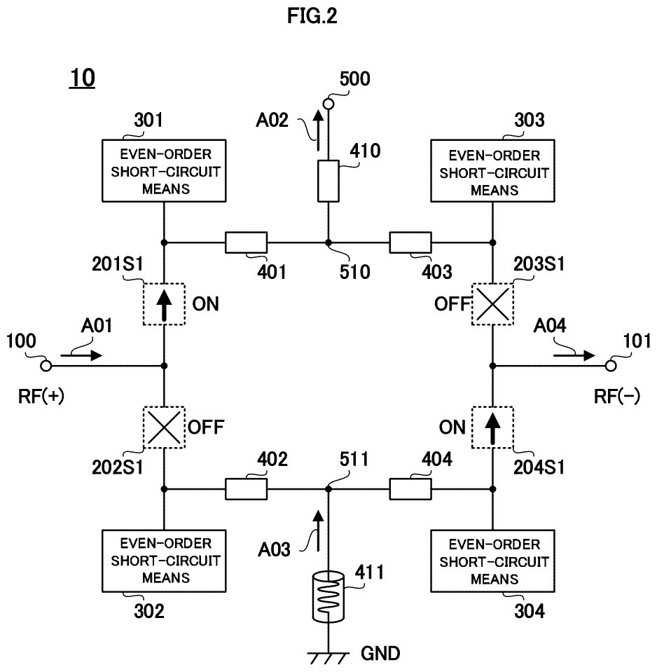

FIG. 2 illustrates the operating states of the diodes 201 to 204 and the current paths in the rectifier circuit 11 when the input terminal 100 side has a positive voltage in an alternating-current voltage supplied to the input terminals 100 and 101. The diodes 201 and 204 are forward biased in a positive half cycle of a high-frequency signal supplied to the input terminals 100 and 101. At this time, the operating state of the diode 201 is an on state 201S1. The operating state of the diode 204 is an on state 204S1. On the other hand, the diodes 202 and 203 are reverse biased. At this time, the operating state of the diode 202 is an off state 202S1. The operating state of the diode 203 is an off state 203S1. An arrow A01 indicates a current flowing from the input terminal 100 into the rectifier circuit 11. This current, as a current indicated by an arrow A02, flows out of the rectifier circuit 11 to the output terminal 500 via the diode 201, the transmission line 401, the connection point 510, and the transmission line 410. An arrow A03 indicates a current flowing from the ground GND into the rectifier circuit 11. This current, as a current indicated by an arrow A04, flows out of the rectifier circuit 11 to the input terminal 101 via the connection point 511, the transmission line 404, and the diode 204.

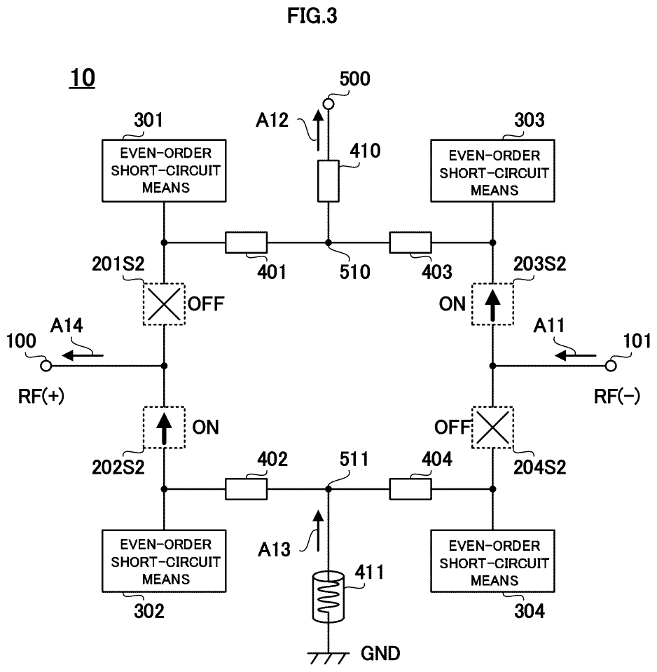

FIG. 3 illustrates the operating states of the diodes 201 to 204 and the current paths in the rectifier circuit 11 when the input terminal 100 side has a negative voltage in the alternating-current voltage supplied to the input terminals 100 and 101. The diodes 201 and 204 are reverse biased in a negative half cycle of the high-frequency signal supplied to the input terminals 100 and 101. At this time, the operating state of the diode 201 is an off state 201S2. The operating state of the diode 204 is an off state 204S2. On the other hand, the diodes 202 and 203 are forward biased. At this time, the operating state of the diode 202 is an on state 202S2. The operating state of the diode 203 is an on state 203S2. An arrow A11 indicates a current flowing from the input terminal 101 into the rectifier circuit 11. This current, as a current indicated by an arrow A12, flows out of the rectifier circuit 11 to the output terminal 500 via the diode 203, the transmission line 403, the connection point 510, and the transmission line 410. An arrow A13 indicates a current flowing from the ground GND into the rectifier circuit 11. This current, as a current indicated by an arrow A14, flows out of the rectifier circuit 11 to the input terminal 100 via the connection point 511, the transmission line 402, and the diode 202.

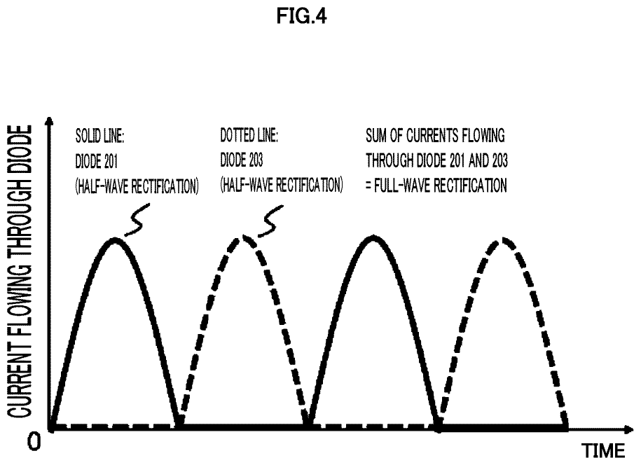

FIG. 4 illustrates time waveforms of currents flowing through the diodes 201 and 203. The positive current direction in FIG. 4 is from the anode to the cathode for each of the diodes 201 and 203. The current flowing through each of the diodes 201 and 203 has a half-wave rectified waveform. In such a configuration, the half-wave rectified waveform includes a direct-current component, an even-order harmonic component, and an odd-order harmonic component. A sum of the currents flowing through the diodes 201 and 203 flows out of the rectifier circuit 11 on the output side thereof. The sum of these currents has a full-wave rectified waveform. The full-wave rectified waveform includes a direct-current component and an even-order harmonic component, and does not include an odd-order harmonic component. Therefore, odd-order harmonics of the wave to be rectified do not flow out of the rectifier circuit 11 to the output terminal 500.

As with the diodes 201 and 203, the current flowing through each of the diodes 202 and 204 also has a half-wave rectified waveform. A sum of the currents flowing through the diodes 202 and 204 flows on the ground side the rectifier circuit 11. The sum of these currents has a full-wave rectified waveform. The full-wave rectified waveform includes a direct-current component and an even-order harmonic component, and does not include an odd-order harmonic component. Therefore, the odd-order harmonics of the wave to be rectified do not flow from the ground GND 11 into the rectifier circuit 11.

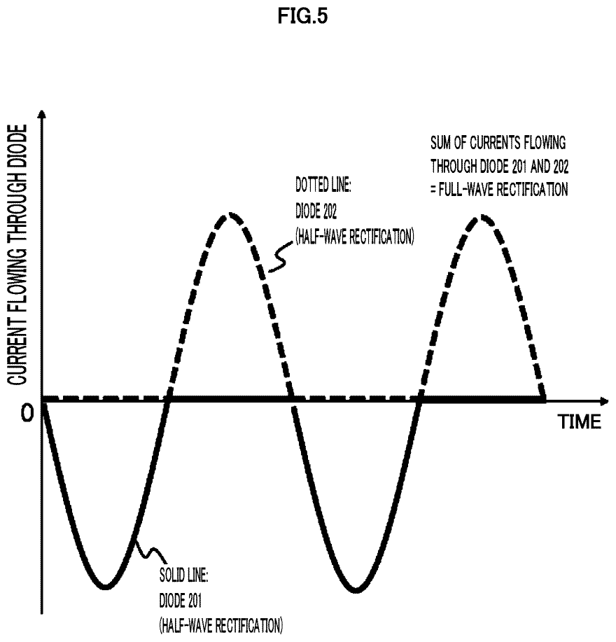

FIG. 5 illustrates time waveforms of the currents flowing through the diodes 201 and 202. The positive current direction in FIG. 5 is from the cathode to the anode for the diode 201, and is from the anode to the cathode for the diode 202. In such a configuration, a sum of the currents flowing through the diodes 201 and 202 is a positive value when flowing from the rectifier circuit 11 to the input terminal 100. The sum of these currents is expressed using an odd function. The sum of the currents flowing through the diodes 201 and 202 does not include an even-order harmonic component.

For the diode 203, the positive current direction is from the cathode to the anode. For the diode 204, the positive current direction is from the anode to the cathode. Therefore, a sum of the currents flowing through the diodes 203 and 204 is a positive value when flowing from the rectifier circuit 11 to the input terminal 101. As with the case of the diodes 201 and 202, the sum of the currents flowing through the diodes 203 and 204 is also expressed using an odd function.

When the even-order short-circuit means 301 to 304 are not provided, the rectifier circuit 11 as a bridge rectifier circuit converts half of each waveform cycle to a direct-current signal containing ripple. The full-wave rectifier circuit rectifies both a positive-voltage side and a negative-voltage side of a waveform, resulting in two pulses per cycle. Thus, the ripple has a frequency twice the frequency of an input signal. The output terminal 500 outputs a direct current converted by the rectifier circuit 11.

The connection point 510, at which the cathode of the diode 201 and the cathode of the diode 203 are connected to each other, is output of the rectifier 10. When the even-order short-circuit means 301 to 304 are not provided, an output waveform at the output terminal 500 includes a direct-current component and an even-order harmonic component. Leakage of the even-order harmonics to the output side reduces the efficiency in the RF-to-DC conversion. In addition, when the even-order harmonics are present, it is impossible or difficult that direct-current output of the rectifier 10 is sufficiently smoothed. When the wave to be rectified has a high frequency exceeding 20 GHz, the even-order harmonics each have a frequency exceeding 40 GHz. In this case, it is difficult to short-circuit an output side of the bridge-connected diodes by capacitors at the even-order harmonics because inductive components of the capacitors have a large influence.

The rectifier 10 according to Embodiment 1 includes the plurality of even-order short-circuit means 301 to 304 that each have one end connected to the output side or ground side of the bridge-connected diodes and the other end being open. The rectifier 10 can prevent leakage of the even-order harmonics to the output side and smooth the output. The even-order short-circuit means 301 is connected to the cathode of the diode 201, and is a first member as a first even-order short-circuit member that is to be short-circuited to the even-order harmonics on the output side of the rectifier circuit 11. The even-order short-circuit means 302 is connected to the anode of the diode 202, and is a second member as a second even-order short-circuit member that is to be short-circuited to the even-order harmonics on the ground side of the rectifier circuit 11. The even-order short-circuit means 303 is connected to the cathode of the diode 203, and is a third member as a third even-order short-circuit member that is to be short-circuited to the even-order harmonics on the output side of the rectifier circuit 11. The even-order short-circuit means 304 is connected to the anode of the diode 204, and is a fourth member as a fourth even-order short-circuit member that is to be short-circuited to the even-order harmonics on the ground side of the rectifier circuit 11. Being short-circuited to the even-order harmonics are also referred to as an even-order short circuit.

The even-order short-circuit means 301 is to be short-circuited to the even-order harmonics at the cathode of the diode 201, that is, have an impedance of zero. The even-order short-circuit means 302 is to be short-circuited to the even-order harmonics at the anode of the diode 202. The even-order short-circuit means 303 is to be short-circuited to the even-order harmonics at the cathode of the diode 203. The even-order short-circuit means 304 is to be short-circuited to the even-order harmonics at the anode of the diode 204. Due to these even-order short circuits, the rectifier 10 including the even-order short-circuit means 301 to 304 prevents leakage of the even-order harmonics to the output side and smooths the output.

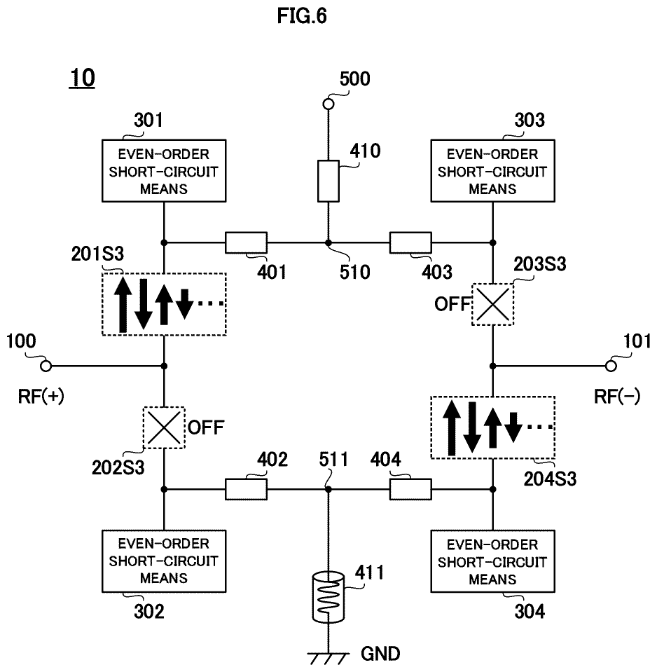

FIG. 6 illustrates current paths of the even-order harmonics in the rectifier 10 including the even-order short-circuit means 301 to 304 when the high-frequency signal supplied to the input terminals 100 and 101 are in the positive half cycle. At this time, the diode 201 is in an operating state 201S3, and the diode 204 is an operating state 204S3. A plurality of arrows illustrated in squares at the positions of the diodes 201 and 204 represent, from left to right, flow of even-order harmonic currents, such as a direct current, a secondary harmonic current, a fourth-order harmonic current, and a sixth-order harmonic current. The illustrated directions of the even-order harmonic currents except for the direct current may not correspond to the actual directions. On the other hand, the diode 202 is in an off state 202S3, and the diode 203 is an off state 203S3. In the operating state 201S3, the anode and cathode of the diode 201 are short-circuited. Moreover, the even-order harmonics generated at the diode 201 are absorbed by the even-order short-circuit means 301. Therefore, the even-order harmonics generated at the diode 201 are confined to the diode 201. In the operating state 204S3, the anode and cathode of the diode 204 are short-circuited. Moreover, the even-order harmonics generated at the diode 204 are absorbed by the even-order short-circuit means 304. Therefore, the even-order harmonics generated at the diode 204 are confined to the diode 204.

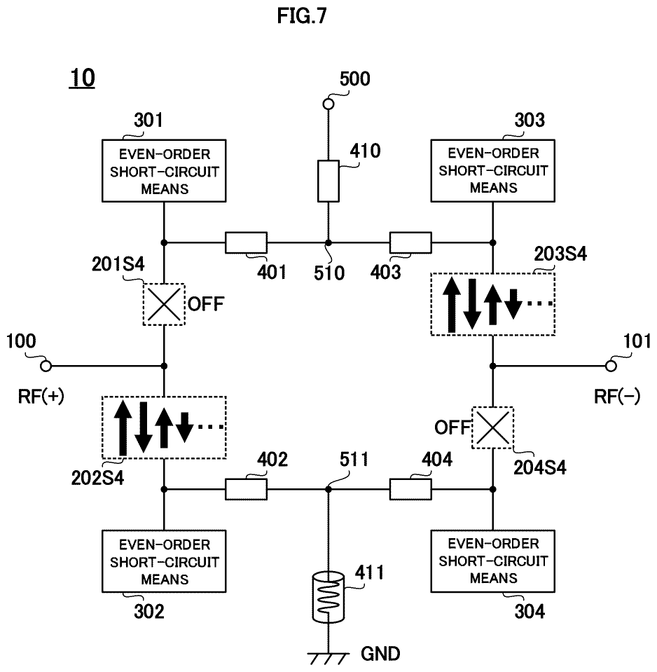

FIG. 7 illustrates current paths of the even-order harmonics in the rectifier 10 including the even-order short-circuit means 301 to 304 when the high-frequency signal supplied to the input terminals 100 and 101 are in the negative half cycle. At this time, the diode 202 is in an operating state 202S4, and the diode 203 is an operating state 203S4. A plurality of arrows illustrated in squares at the positions of the diodes 202 and 203 represent, from left to right, flow of the even-order harmonic currents, such as the direct current, the secondary harmonic current, the fourth-order harmonic current, and the sixth-order harmonic current. The illustrated directions of the even-order harmonic currents except for the direct currents may not correspond to the actual directions. On the other hand, the diode 201 is in an off state 201S4, and the diode 204 is an off state 204S4. In the operating state 202S4, the anode and cathode of the diode 202 are short-circuited. Moreover, the even-order harmonics generated at the diode 202 are absorbed by the even-order short-circuit means 302. Therefore, the even-order harmonics generated at the diode 202 are confined to the diode 202. In the operating state 203S4, the anode and cathode of the diode 203 are short-circuited. Moreover, the even-order harmonics generated at the diode 203 are absorbed by the even-order short-circuit means 303. Therefore, the even-order harmonics generated at the diode 203 are confined to the diode 203.

In each of the cycles of the high-frequency signal, each of the diodes 201 to 204 is switched between the on and off states. Each of the even-order short-circuit means 301 to 304 disposed respectively corresponding to the diodes 201 to 204 is to be short-circuited to at least one of the even-order harmonics on the output side or ground side of the rectifier circuit 11. Therefore, the even-order harmonics generated by switching of each of the diodes 201 to 204 can be confined to a terminal to which each of the diodes 201 to 204 is connected. Thus, the rectifier 10 can prevent leakage of the even-order harmonics to the output side and thereby achieve high efficiency in the RF-to-DC conversion. The output terminal 500 outputs a direct current in which the ripple caused by the even-order harmonics is suppressed by the smoothing function of the even-order short-circuit means 301 to 304.

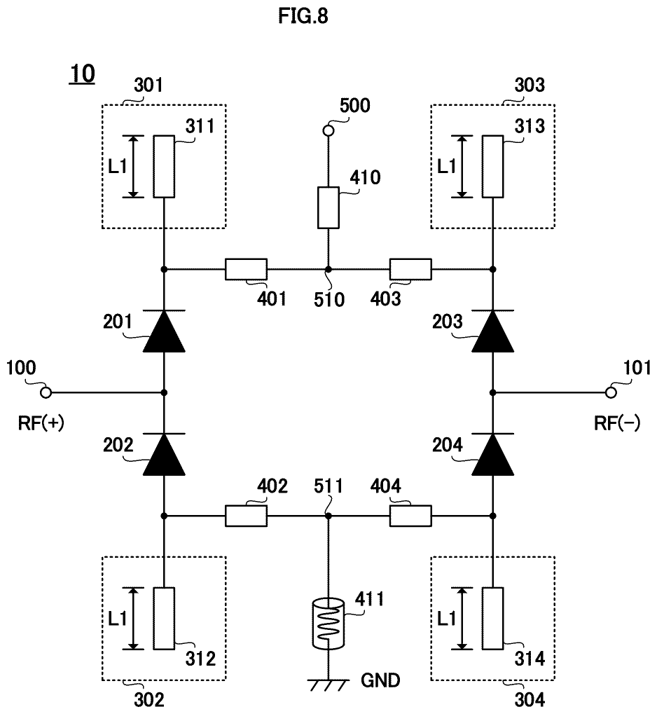

FIG. 8 illustrates an exemplary configuration of the rectifier 10. Each of the even-order short-circuit means 301 to 304 in FIG. 8 is one open stub using a transmission line. The even-order short-circuit means 301 includes a line member 311 that has an electrical length L1 one quarter a wavelength of a secondary harmonic of the wave to be rectified. The even-order short-circuit means 302 includes a line member 312 that has the electrical length L1 one quarter the wavelength of the secondary harmonic of the wave to be rectified. The even-order short-circuit means 303 includes a line member 313 that has the electrical length L1 one quarter the wavelength of the secondary harmonic of the wave to be rectified. The even-order short-circuit means 304 includes a line member 314 that has the electrical length L1 one quarter the wavelength of the secondary harmonic of the wave to be rectified.

In the even-order short-circuit means 301 that is disposed corresponding to the diode 201, the line member 311 has one end connected to the cathode of the diode 201 and the other end being open. In the even-order short-circuit means 302 that is disposed corresponding to the diode 202, the line member 312 has one end connected to the anode of the diode 202 and the other end being open. In the even-order short-circuit means 303 that is disposed corresponding to the diode 203, the line member 313 has one end connected to the cathode of the diode 203 and the other end being open. In the even-order short-circuit means 304 that is disposed corresponding to the diode 204, the line member 314 has one end connected to the cathode of the diode 204 and the other end being open. In the configuration illustrated in FIG. 8, the line members 311 and 313 disposed on the output side of the rectifier circuit 11 and the line members 312 and 314 disposed on the ground side of the rectifier circuit 11 short-circuit the secondary harmonic of the wave to be rectified.

When being switched between the on and off states, the bridge-connected diodes of the full-wave rectifier circuit generate higher levels of harmonic signals at lower harmonic orders. The lower harmonic orders have a larger influence on the efficiency in the RF-to-DC conversion. The rectifier 10 illustrated in FIG. 8 prevents leakage of the secondary harmonic, which has the largest influence on the efficiency in the RF-to-DC conversion, to the output side.

Each of the even-order short-circuit means 301 to 304 in FIG. 8 is an even-order short-circuit member including one line member. The output of the rectifier circuit 11 can be smoothed by the even-order short-circuit means 301 to 304, thus eliminating the need for the capacitors as smoothing elements. Thus, high conversion efficiency in rectifying a high-frequency current with a frequency exceeding 20 GHz can be achieved with a simple circuit configuration. In addition, the rectifier 10 without the capacitors can reduce variations in performance. The simple configuration for preventing leakage of the secondary harmonic to the output side allows a device to be smaller.

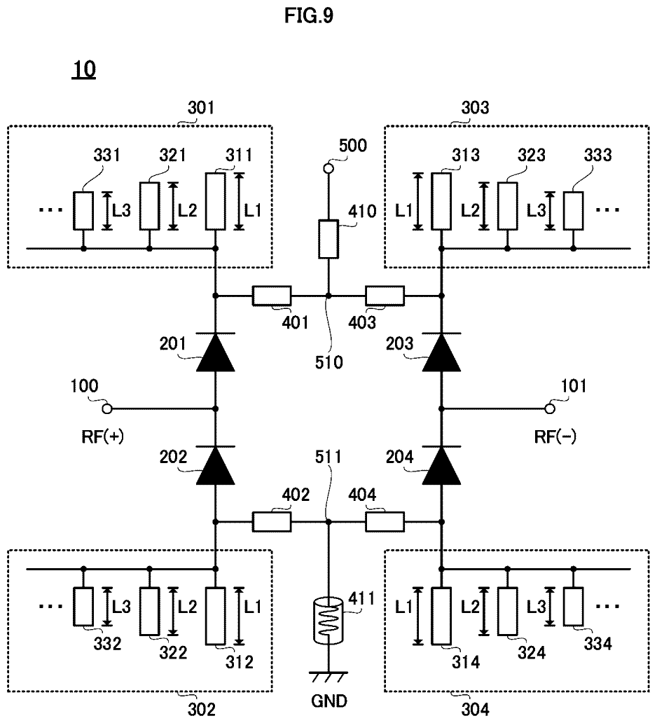

FIG. 9 illustrates another exemplary configuration of the rectifier 10. Each of the even-order short-circuit means 301 to 304 in FIG. 9 includes a plurality of open stubs corresponding to the even-order harmonics of the wave to be rectified, such as secondary, fourth-order, and sixth-order harmonics. The even-order short-circuit means 301 includes, in addition to the line member 311, line members 321 and 331. The line member 321 has an electrical length L2 one quarter a wavelength of the fourth-order harmonic of the wave to be rectified. The line member 331 has an electrical length L3 one quarter a wavelength of the sixth-order harmonic of the wave to be rectified. The even-order short-circuit means 302 includes, in addition to the line member 312, line members 322 and 332. The line member 322 has the electrical length L2 one quarter the wavelength of the fourth-order harmonic of the wave to be rectified. The line member 332 has the electrical length L3 one quarter the wavelength of the sixth-order harmonic of the wave to be rectified. The even-order short-circuit means 303 includes, in addition to the line member 313, line members 323 and 333. The line member 323 has the electrical length L2 one quarter the wavelength of the fourth-order harmonic of the wave to be rectified. The line member 333 has the electrical length L3 one quarter the wavelength of the sixth-order harmonic of the wave to be rectified. The even-order short-circuit means 304 includes, in addition to the line member 314, line members 324 and 334. The line member 324 has the electrical length L2 one quarter the wavelength of the fourth-order harmonic of the wave to be rectified. The line member 334 has the electrical length L3 one quarter the wavelength of the sixth-order harmonic of the wave to be rectified. Each of the even-order short-circuit means 301 to 304 may include an open stub having an electrical length one quarter a wavelength of an eighth-order or higher even-order harmonic. Each of the even-order short-circuit means 301 to 304 may include two open stubs each having an electrical length one quarter the wavelength of each of the secondary and fourth-order harmonics. Each of the even-order short-circuit means 301 to 304 may include a plurality of open stubs each having an electrical length one quarter a wavelength of each of a plurality of even-order harmonics.

As with the configuration in FIG. 8, the line members 311 to 314 in FIG. 9 are to be short-circuited to the secondary harmonic. In the even-order short-circuit means 301 that is disposed corresponding to the diode 201, each of the line members 321 and 331 has one end connected to the cathode of the diode 201 and the other end being open. In the even-order short-circuit means 302 that is disposed corresponding to the diode 202, each of the line members 322 and 332 has one end connected to the anode of the diode 202 and the other end being open. In the even-order short-circuit means 303 that is disposed corresponding to the diode 203, each of the line members 323 and 333 has one end connected to the cathode of the diode 203 and the other end being open. In the even-order short-circuit means 304 that is disposed corresponding to the diode 204, each of the line members 324 and 334 has one end connected to the anode of the diode 204 and the other end being open. In the configuration illustrated in FIG. 9, the line members 321 and 323 disposed on the output side of the rectifier circuit 11 and the line members 322 and 324 disposed on the ground side of the rectifier circuit 11 are short-circuited to the fourth-order harmonic of the wave to be rectified. In the configuration illustrated in FIG. 9, the line members 331 and 333 disposed on the output side of the rectifier circuit 11 and the line members 332 and 334 disposed on the ground side of the rectifier circuit 11 are to be short-circuited to the sixth-order harmonic of the wave to be rectified. In addition, each of the even-order short-circuit means 301 to 304 may include a line member to be short-circuited to any even-order harmonic.

Each of the even-order short-circuit means 301 to 304 in FIG. 9 is an even-order short-circuit member including a plurality of line members. In the configuration in FIG. 9, the rectifier 10 has a larger circuit size than in the configuration in FIG. 8. However, the rectifier 10 in FIG. 9 is more effective in preventing leakage of the even-order harmonics to the output side. Therefore, the rectifier 10 with the configuration in FIG. 9 has higher efficiency in the RF-to-DC conversion than that with the configuration in FIG. 8.

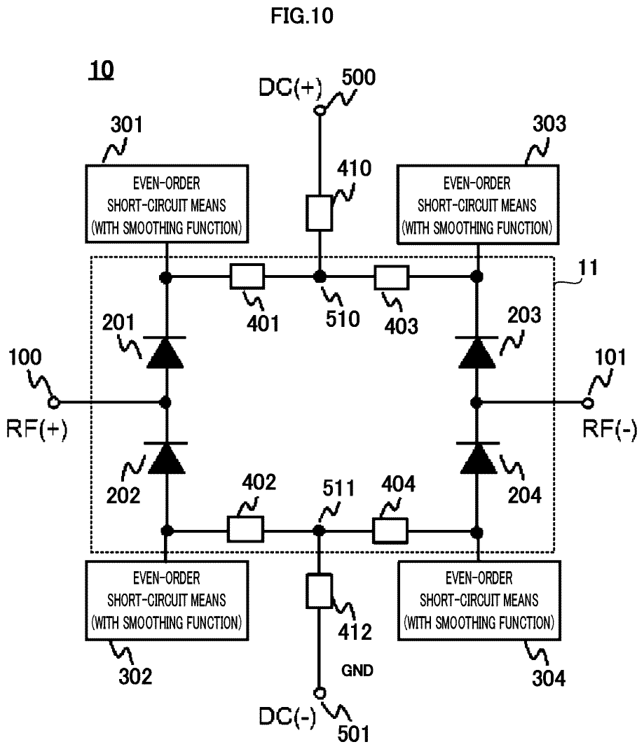

FIG. 10 illustrates another exemplary configuration of the rectifier 10. The rectifier circuit 11 in FIG. 10 is connected to an output terminal 501 from the connection point 511 via a transmission line 412. The output terminals 500 and 501 are direct-current output terminals differentially outputting a direct current.

In the configuration in FIG. 10, the connection point 511 connected to the anode of the diode 202 and the anode of the diode 204 provides the output of the rectifier 10. The anode of the diode 202 is connected to the connection point 511 via the transmission line 402 on the output side of the rectifier circuit 11. The anode of the diode 204 is connected to the connection point 511 via the transmission line 404 on the output side of the rectifier circuit 11. The connection point 511 is connected to the output terminal 501 via the transmission line 412. The configuration in FIG. 10 is the same as the configuration in FIG. 1 in the configuration in which the anode of the diode 201 and the cathode of the diode 202 are connected to the input terminal 100, the configuration in which the anode of the diode 202 and the cathode of the diode 204 are connected to the input terminal 101, and the configuration of the diodes 201 and 203 on the cathode side thereof.

The rectifier 10 in FIG. 10 includes the plurality of even-order short-circuit means 301 to 304 that each have one end connected to the output side of the bridge-connected diodes and the other end being open. The even-order short-circuit means 301 is connected to the cathode of the diode 201, and is the first even-order short-circuit member to be short-circuited to the even-order harmonics on the output side of the rectifier circuit 11. The even-order short-circuit means 302 is connected to the anode of the diode 202, and is the second even-order short-circuit member to be short-circuited to the even-order harmonics on the output side of the rectifier circuit 11. The even-order short-circuit means 303 is connected to the cathode of the diode 203, and is the third even-order short-circuit member to be short-circuited to the even-order harmonics on the output side of the rectifier circuit 11. The even-order short-circuit means 304 is connected to the anode of the diode 204, and is the fourth even-order short-circuit member to be short-circuited to the even-order harmonics on the output side of the rectifier circuit 11.

Each of the even-order short-circuit means 301 to 304 in FIG. 10 is an even-order short-circuit member including one or a plurality of line members. Each of the even-order short-circuit means 301 to 304 may include a line member to be short-circuited to any even-order harmonic. In the configuration in FIG. 10, the output of the rectifier circuit 11 can be smoothed by the even-order short-circuit means 301 to 304, and the rectifier 10 thus does not require the capacitors as smoothing elements. Thus, the rectifier 10 can achieve high conversion efficiency with a simple circuit configuration. In addition, the rectifier 10 without the capacitors can reduce variations in performance.

As described above, the rectifier 10 includes the rectifier circuit 11 that uses the plurality of diodes 201 to 204, and the plurality of even-order short-circuit means 301 to 304 that are connected to the rectifier circuit 11. The rectifier circuit 11 generates a direct-current component upon input of a wave to be rectified. The even-order short-circuit means 301 to 304 include a plurality of line members, such as the line members 311 to 314. Each of the plurality of line members included in the even-order short-circuit means 301 to 304 is an even-order short-circuit member that has an impedance of zero, that is, is short-circuited to at least one of even-order harmonics of the wave to be rectified and smooths the output of the rectifier circuit 11, and has one end connected to one of the diodes 201 to 204 and the other end being open. Thus, the rectifier 10 has a simple circuit configuration that eliminates the need for the capacitors as smoothing elements, and thus can achieve high conversion efficiency and reduce variations in performance. The rectifier 10 may be used with the capacitors connected to the output terminals thereof.

### Embodiment 2

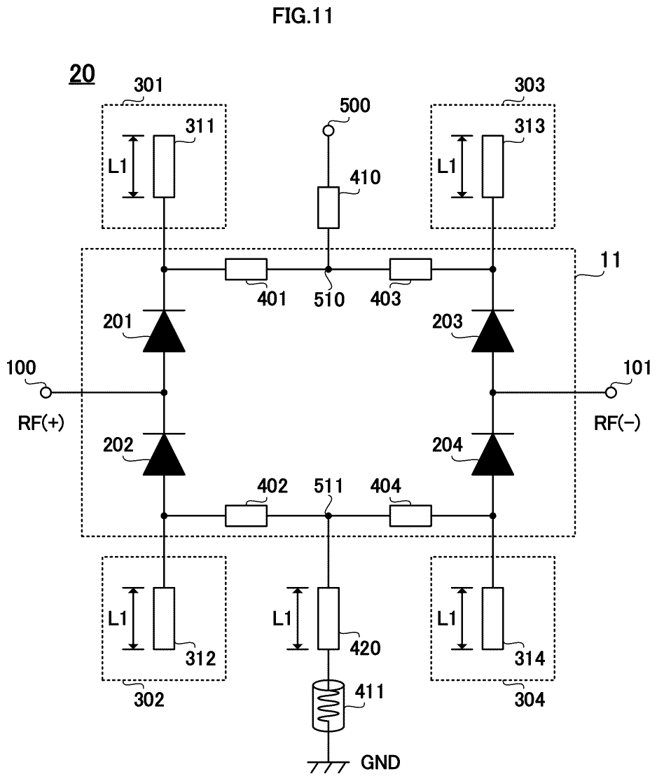

FIG. 11 illustrates an exemplary configuration of a rectifier 20 according to Embodiment 2 of the present disclosure. As with the rectifier 10, the rectifier 20 includes the rectifier circuit 11, the input terminals 100 and 101, the plurality of even-order short-circuit means 301 to 304, and the output terminal 500. In contrast to the rectifier 10, the rectifier 20 includes a transmission line 420 inserted between the connection point 511 included in the rectifier circuit 11 and the via 411. The transmission line 420 has the electrical length L1 that is one quarter the wavelength of the secondary harmonic of the wave to be rectified. Due to the even-order short circuits caused by the even-order short-circuit means 301 to 304, the rectifier 20 can prevent leakage of the even-order harmonics to the output side and smooth output.

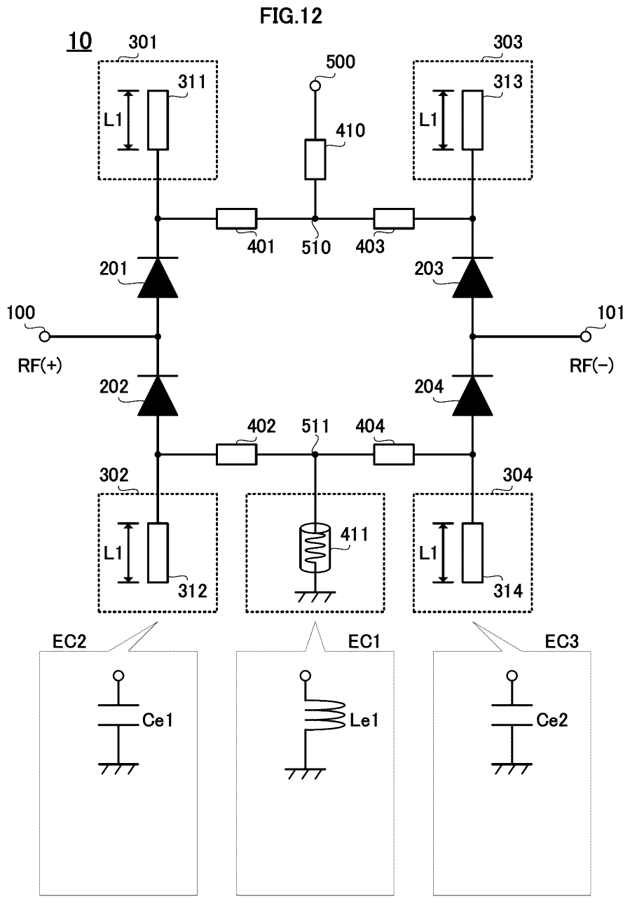

FIG. 12 is a diagram for explanation of a problem in the rectifier 10. The rectifier 10 according to Embodiment 1 as illustrated in FIG. 8 may reduce the effects achieved by the even-order short circuits when variations in substrate wiring patterns occur. In the rectifier 10, the connection point 511 is connected to the ground GND via the via 411. The transmission line passing through the via 411 can be replaced by an equivalent circuit EC1 that includes an inductor Le1. Therefore, the connection point 511 is equivalently expressed by a circuit loaded with the inductor Le1.

The line member 312 of the even-order short-circuit means 302 and the line member 314 of the even-order short-circuit means 304 have the electrical length L1 that is one quarter the wavelength of the secondary harmonic of the wave to be rectified. However, the electrical lengths of the line members 312 and 314 are assumed to be shorter than one quarter the wavelength of the secondary harmonic when the variations in substrate wiring patterns occur. In this assumption, the line member 312 can be replaced by an equivalent circuit EC2 that includes a capacitor Ce1, and the line member 314 can be replaced by an equivalent circuit EC3 that includes a capacitor Ce2. Therefore, the line member 312 is equivalently expressed by a circuit loaded with the capacitor Ce1. The line member 314 is equivalently expressed by a circuit loaded with the capacitor Ce2.

In the equivalent circuits EC1 to EC3, parallel resonance at the secondary harmonic may occur between the inductor Le1 and the capacitors Ce1 and Ce2. When this parallel resonance occurs, a composite impedance as viewed from a connection point of the anode of the diode 202 and the anode of the diode 204 is to be open or infinite to the secondary harmonic. Therefore, the line members 312 and 314 are deemed equivalently unconnected, thus reducing the effects achieved by the even-order short circuits.

The rectifier 20 illustrated in FIG. 11 has a configuration in which the transmission line 420 is disposed between the connection point 511 and the via 411. The transmission line 420 is a ground-side line member connected to the ground side of the rectifier circuit 11 and having the electrical length L1 one quarter the wavelength of the secondary harmonic of the wave to be rectified. In this configuration, the impedance on the via 411 side as viewed from the connection point 511 is set to be open to the secondary harmonic. The via 411 is to be equivalently unconnected to the secondary harmonic. In other words, the via 411 can be treated as non-existent for the secondary harmonic. Since the connection point 511 of the rectifier circuit 11 is not connected to the via 411 at the second harmonic, the equivalent capacitor Cel of the line member 312 and the equivalent capacitor Ce2 of the line member 314 do not generate parallel resonance with the equivalent inductor Lel of the via 411 at the secondary harmonic. Thus, the rectifier 20 provided with the transmission line 420 can prevent performance degradation due to the variations in substrate wiring patterns.

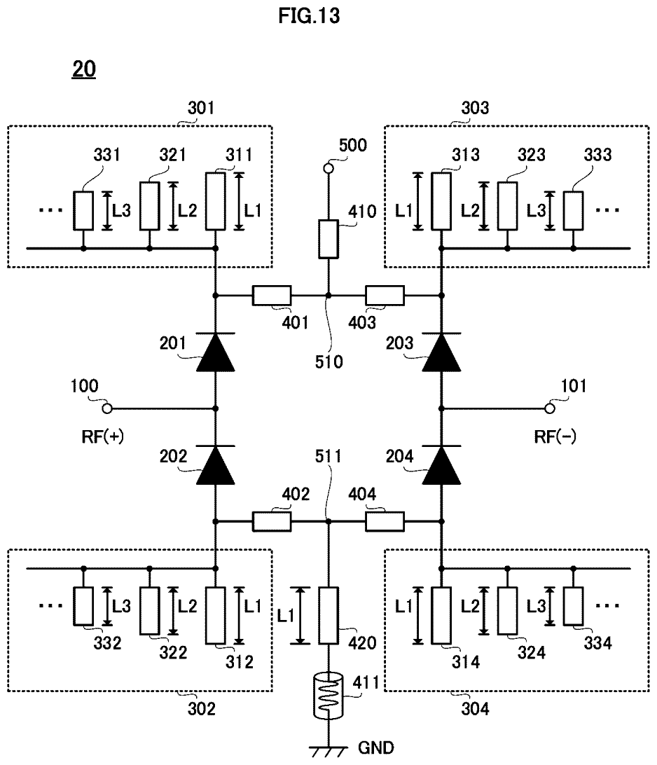

FIG. 13 illustrates another exemplary configuration of the rectifier 20. Each of the even-order short-circuit means 301 to 304 in FIG. 13 includes a plurality of open stubs corresponding to the even-order harmonics of the wave to be rectified, such as the secondary, fourth-order, and sixth-order harmonics. The rectifier 20 in FIG. 13 has a different configuration than the rectifier 10 in FIG. 9 because of the transmission line 420 disposed between the connection point 511 and the via 411. The transmission line 420 has the electrical length L1 that is one quarter the wavelength of the secondary harmonic of the wave to be rectified. Thus, the connection point 511 of the rectifier circuit 11 is not connected to the via 411 at the secondary harmonic. Therefore, the capacitors Ce1 and Ce2 of the line members 312 and 314 do not generate parallel resonance with the inductor Le1 of the via 411 at the secondary harmonic.

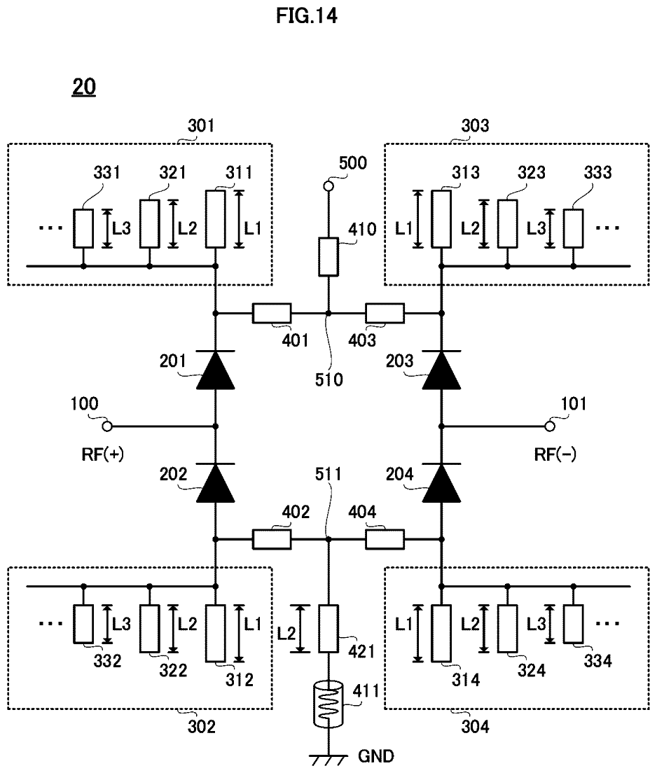

FIG. 14 illustrates another exemplary configuration of the rectifier 20. The rectifier 20 in FIG. 14 has a configuration in which a transmission line 421 is disposed between the connection point 511 and the via 411. The transmission line 421 is a line member having the electrical length L2 one quarter the wavelength of the fourth-order harmonic of the wave to be rectified. In this configuration, the impedance on the via 411 side as viewed from the connection point 511 is set to be open to the fourth-order harmonic. The connection point 511 of the rectifier circuit 11 is not connected to the via 411 at the fourth-order harmonic. Therefore, the equivalent capacitor of the line member 322 and the equivalent capacitor of the line member 324 do not generate parallel resonance with the equivalent inductor of the via 411 at the fourth-order harmonic. In addition, a configuration may be provided in which the transmission line connected between the rectifier circuit 11 and the via 411 has an electrical length one quarter the wavelength of any one even-order harmonic such that the connection point 511 of the rectifier circuit 11 is not connected to the via 411 at the above even-order harmonic.

### Embodiment 3

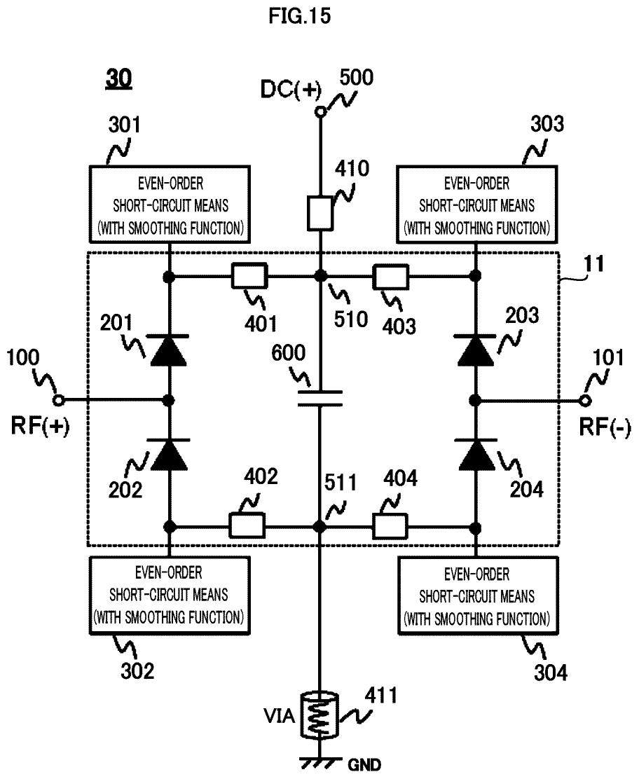

FIG. 15 illustrates an exemplary configuration of a rectifier 30 according to Embodiment 3 of the present disclosure. As with the rectifier 10 in FIG. 1, the rectifier 30 includes the rectifier circuit 11, the input terminals 100 and 101, the plurality of even-order short-circuit means 301 to 304, and the output terminal 500. In contrast to the rectifier 10 in FIG. 1, the rectifier 30 includes a capacitor 600 that is connected between the connection points 510 and 511 included in the rectifier circuit 11. The connection point 510 illustrated in FIG. 15 is connected to the output terminal 500 via the transmission line 410. The connection point 511 illustrated in FIG. 15 is grounded by being connected to the ground GND on the backside surface of the substrate via the via 411. The capacitor 600 has one end connected to the connection point 510 on the output side of the rectifier circuit 11 and the other end connected to the connection point 511 on the ground side of the rectifier circuit 11. As described above, the rectifier 30 in FIG. 15 includes the capacitor 600 that has one end connected to the output side of the rectifier circuit 11 and the other end connected to the ground side of the rectifier circuit 11.

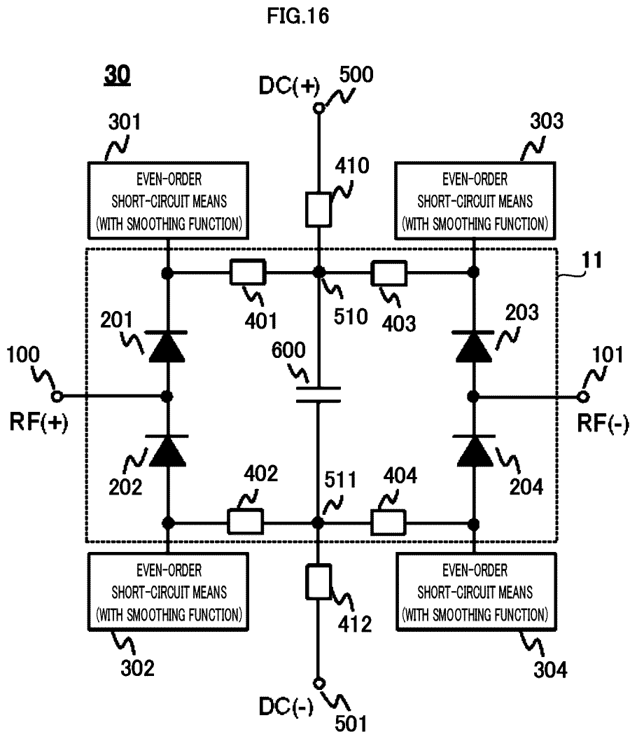

FIG. 16 illustrates another exemplary configuration of the rectifier 30. As with the rectifier 10 in FIG. 10, the rectifier circuit 11 included in the rectifier 30 in FIG. 16 is connected to the output terminal 501 from the connection point 511 via the transmission line 412. The output terminals 500 and 501 are direct-current output terminals differentially outputting a direct current. In contrast to the rectifier 10 in FIG. 10, the rectifier 30 includes the capacitor 600 that is connected between the connection points 510 and 511 included in the rectifier circuit 11. The connection point 510 illustrated in FIG. 16 is connected to the output terminal 500 via the transmission line 410. The connection point 511 illustrated in FIG. 16 is connected to the output terminal 501 via the transmission line 412. The capacitor 600 has, on the output side of the rectifier circuit 11, one end connected to the connection point 510 that corresponds to one of differential outputs, and the other end connected to the connection point 511 that corresponds to the other of the differential outputs. As described above, the rectifier 30 in FIG. 16 includes the capacitor 600 that has one end connected to one of the differential outputs and the other end connected to the other of the differential outputs.

In the configurations in FIGS. 15 and 16, the capacitor 600 prevents leakage, to the output side, of low-frequency noise that is noise having a lower frequency than a fundamental wave flowing into the rectifier 30. This allows the rectifier 30 to reduce noise included in the output. The capacitor 600 can be determined to have any capacitance value to prevent leakage of the low-frequency noise. It is sufficient to determine the capacitance value of the capacitor 600 based on radio environment in which the rectifier 30 is installed.

In the rectifier 30, due to the even-order short circuits, the even-order short-circuit means 301 to 304 can prevent leakage of the even-order harmonics to the output side and smooth the output. The capacitor 600 is intended to reduce the low-frequency noise, and application thereof differs from that of a smoothing capacitor included in a conventional rectifier. The rectifier 30 can achieve high efficiency in the RF-to-DC conversion by harmonic processing and smoothing performed by the even-order short-circuit means 301 to 304. In addition, the rectifier circuit 30 can improve resistance to the low-frequency noise with the capacitor 600.

In the configurations in FIGS. 11, 13, and 14, the capacitor 600 may be connected between the connection points 510 and 511. The rectifier 20 in FIGS. 11 and 13 includes the transmission line 420 that is inserted between the connection point 511 included in the rectifier circuit 11 and the via 411. The transmission line 420 has the electrical length L1 that is one quarter the wavelength of the secondary harmonic of the wave to be rectified. The rectifier 20 in FIG. 14 includes the transmission line 421 that is inserted between the connection point 511 included in the rectifier circuit 11 and the via 411. The transmission line 421 has the electrical length L2 that is one quarter the wavelength of the fourth-order harmonic of the wave to be rectified. Also in such configurations, the capacitor 600 is intended to reduce the low-frequency noise, and application thereof differs from that of a smoothing capacitor included in a conventional rectifier. The rectifier 20 in FIGS. 11, 13, and 14 can achieve high efficiency in the RF-to-DC conversion by harmonic processing and smoothing performed by the even-order short-circuit means 301 to 304. The transmission lines 420 and 421 do not generate parallel resonance at the harmonics, and thus can prevent performance degradation due to variations in substrate wiring patterns. Moreover, the rectifier 20 to which the capacitor 600 is added can improve resistance to the low-frequency noise.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2023-070750, filed on Apr. 24, 2023, including the specification, claims, drawings, and abstract, the entire disclosure of which is incorporated by reference herein.

### REFERENCE SIGNS LIST

10,20,30 Rectifier
11 Rectifier circuit
100, 101 Input terminal
201 to 204 Diode
301 to 304 Even-order short-circuit means
311 to 314, 321 to 324, 331 to 334 Line member
401 to 404, 410, 412, 420, 421 Transmission line
411 Via
500, 501 Output terminal
510, 511 Connection point
600 Capacitor

1. A rectifier comprising:
a rectifier circuit including a plurality of diodes, the rectifier circuit being configured to generate a direct-current component upon input of a wave to be rectified;
a plurality of line members connected to the rectifier circuit, wherein
the plurality of diodes includes
a first diode having an anode connected to an input side of the rectifier circuit and a cathode connected to an output side of the rectifier circuit,
a second diode having a cathode connected to the input side of the rectifier circuit and an anode connected to the output side of the rectifier circuit,
a third diode having an anode connected to the input side of the rectifier circuit and a cathode connected to the output side of the rectifier circuit, and
a fourth diode having a cathode connected to the input side of the rectifier circuit and an anode connected to the output side of the rectifier circuit,
each of the plurality of line members is an even-order short-circuit member to have an impedance of zero at at least one of even-order harmonics of the wave to be rectified and smooth output of the rectifier circuit, and
the plurality of line members includes
a first member having one end connected to the cathode of the first diode and the other end being open,
a second member having one end connected to the anode of the second diode and the other end being open,
a third member having one end connected to the cathode of the third diode and the other end being open, and
a fourth member having one end connected to the anode of the fourth diode and the other end being open.

2. The rectifier according to claim 1, further comprising:
an output terminal to output a single-phase direct current on the output side of the rectifier circuit.

3. The rectifier according to claim 2, wherein
the rectifier circuit has a ground side grounded via a via.

4. The rectifier according to claim 3, further comprising:
a ground-side line member disposed between the ground side of the rectifier circuit and the via, wherein
the ground-side line member has an electrical length one quarter a wavelength of one of the even-order harmonics of the wave to be rectified, and the rectifier circuit has a connection point to be not connected to the via at the one of the even-order harmonics of the wave to be rectified.

5. The rectifier according to claim 1, further comprising:
a capacitor having one end connected to the output side of the rectifier circuit and the other end connected to the ground side of the rectifier circuit.

6. The rectifier according to claim 1, further comprising:
an output terminal to differentially output a direct current on the output side of the rectifier circuit.

7. The rectifier according to claim 6, further comprising:
a capacitor having one end connected to one of differential outputs and the other end connected to the other of the differential outputs.

8. The rectifier according to claim 1, wherein
each of the plurality of line members is one open stub having an electrical length one quarter a wavelength of a secondary harmonic of the wave to be rectified.

9. The rectifier according to claim 1, wherein
the plurality of line members is a plurality of open stubs each having an electrical length one quarter a wavelength of each of the even-order harmonics of the wave to be rectified.

10. The rectifier according to claim 2, further comprising:
a capacitor having one end connected to the output side of the rectifier circuit and the other end connected to the ground side of the rectifier circuit.

11. The rectifier according to claim 3, further comprising:
a capacitor having one end connected to the output side of the rectifier circuit and the other end connected to the ground side of the rectifier circuit.

12. The rectifier according to claim 4, further comprising:
a capacitor having one end connected to the output side of the rectifier circuit and the other end connected to the ground side of the rectifier circuit.

13. The rectifier according to claim 2, wherein
each of the plurality of line members is one open stub having an electrical length one quarter a wavelength of a secondary harmonic of the wave to be rectified.

14. The rectifier according to claim 3, wherein
each of the plurality of line members is one open stub having an electrical length one quarter a wavelength of a secondary harmonic of the wave to be rectified.

15. The rectifier according to claim 4, wherein
each of the plurality of line members is one open stub having an electrical length one quarter a wavelength of a secondary harmonic of the wave to be rectified.

16. The rectifier according to claim 5, wherein
each of the plurality of line members is one open stub having an electrical length one quarter a wavelength of a secondary harmonic of the wave to be rectified.

17. The rectifier according to claim 6, wherein
each of the plurality of line members is one open stub having an electrical length one quarter a wavelength of a secondary harmonic of the wave to be rectified.

18. The rectifier according to claim 7, wherein
each of the plurality of line members is one open stub having an electrical length one quarter a wavelength of a secondary harmonic of the wave to be rectified.

19. The rectifier according to claim 2, wherein
the plurality of line members is a plurality of open stubs each having an electrical length one quarter a wavelength of each of the even-order harmonics of the wave to be rectified.

20. The rectifier according to claim 3, wherein
the plurality of line members is a plurality of open stubs each having an electrical length one quarter a wavelength of each of the even-order harmonics of the wave to be rectified.
